(19) United States
(12) Patent Application Publication
(10) Pub. No.: US 2009/0012948 A1
(43) Pub. Date: Jan. 8, 2009

(54) SYSTEM AND METHOD FOR TRANSLATING AND EXECUTING QUERIES

(76) Inventors: Wolfgang Koch, Oestringen (DE); Rainer Brendle, Mountain View, CA (US); Jan Karstens, Mannheim (DE); Gunther Liebich, Walldorf (DE); Andreas Wildhagen, Angelbachtal (DE)

Correspondence Address: KENYON & KENYON LLP, 1500 K STREET N.W., WASHINGTON, DC, 20005, US

(21) Appl. No.: 11/760,483

(22) Filed: Jun. 8, 2007

(51) Int. Cl. G06F 7/06; G06F 17/30

(52) U.S. Cl. 707/4; 707/E17.014

(57) ABSTRACT

Methods and systems for converting standardized, structured queries into native business object queries are provided. The structured queries may be defined in a business object-specific structured query language (BQL). A BQL engine can translate the structured query into a query suited for use by the appropriate business object. In an embodiment, the BQL engine and the related query language provide the primary interface to backend applications and business objects. Embodiments may include a search infrastructure to create indexed views of business objects and a local client proxy to handle requests not handled by indexed views.

### BACKGROUND

Modern firms use complex business systems to define and perform the business processes used by the firms. The business system typically includes a variety of backend applications to perform related tasks and define related processes, such as inventory management, employee management, customer relations, etc. Each application makes use of a variety of business objects, which contain data and business logic to manipulate the data.

Typically, the user interface used to access these backend applications does not include any business or functional logic itself. Rather, the backend applications provide functions and services to the user interface, which provides communication between a user and the applications using the services provided by the applications. Thus, the functionality presented by the user interface is limited by the services exposed by the backend applications.

In many cases the user interface may be created by a different entity than the backend applications. For example, a customer might purchase a generic business system from a supplier, then create (or have created by a second supplier) a customized user interface. Creating the client (frontend) interface may be problematic for a variety of reasons. Often, it requires creating large amounts of functionality to interface with various data sources in the business system. Since each business object and/or backend application might have a different interface, this can require large amounts of time and work. Similarly, data received from various data sources in the business system may have different formatting and structure. To present a consistent user interface, client applications may have to harmonize data received from these disparate sources.

A second problem that may be encountered is that the backend applications may return too much data. Since the services exposed by the backend applications are fixed, there is no way for a frontend client application to define the amount or granularity of data that is received in response to a request. For example, a client application may want to know only those financial transactions that occurred in the last day. If the relevant backend application is only configured to provide transaction data grouped by week, a large amount of unnecessary data will be transmitted to the client. This extraneous data can consume network and local computer resources, in addition to requiring extra processing at the client end.

Another problem can occur when the services exposed by the backend application are designed specifically for creating user interfaces. In some cases, a client interface may want to perform extensive retrieval of data stored in the business objects, such as for data mining operations. Since the exposed services are not designed specifically for data retrieval, it may be computationally prohibitive make a sufficient number of requests to retrieve the desired data. This problem may be compounded when data from multiple business objects and/or nodes is required, since many requests to each node may be necessary.

Thus there is a need in the art for a uniform, flexible way to access the data stored in and services provided by business objects without creating a node- or business object-specific implementation for each node.

### BRIEF DESCRIPTION OF THE DRAWINGS

FIG. 1 shows a business system having a BQL engine according to an embodiment of the present invention.

FIG. 2 shows an exemplary request and service execution in an embodiment of the present invention.

FIG. 3 shows a specific, non-limiting example of data flow, queries and results according to an embodiment of the invention.

FIG. 4 shows an exemplary structure for a structured query according to the present invention.

FIG. 5 shows an exemplary BQL engine including a fast search infrastructure 103 and a local client proxy according to an embodiment of the present invention.

FIG. 6 shows an exemplary process used by a structured query engine according to an embodiment of the present invention.

### DETAILED DESCRIPTION

Methods and systems for building client-defined queries from structured business object data are provided. The queries may be defined in a business object-specific structured query language (BQL). The BQL engine can translate the structured query into a query suited for use by the appropriate business object. In an embodiment, the BQL engine and the related query language provide the primary interface to backend applications and business objects. Embodiments may include a search infrastructure to create indexed views of business objects and a local client proxy to handle requests that are not handled by indexed views, by operating on a business object directly.

Since the structured query is written in a pre-defined structured language, relatively little code or processing is required to construct the query in a client application. Similarly, a developer or user of the client application can use the structured language to specify the amount and format of data desired, which can decrease the amount of data sent by a backend application in response to the query. Thus, embodiments of the present invention may allow for faster and more efficient client applications.

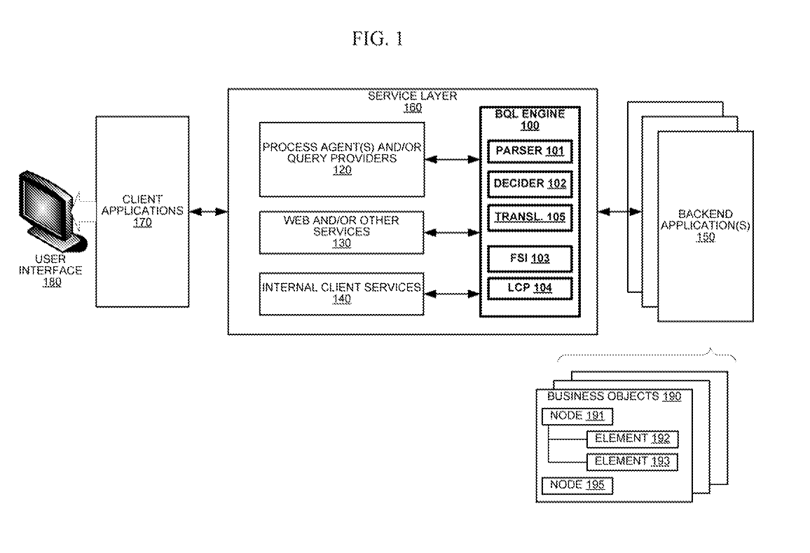

FIG. 1 shows a business system having a BQL engine. Client applications 170 may display a user interface 180 to allow a user to navigate and operate the business system. Typically, the client applications 170 interact with a service layer 160, which provides various interfaces to the business system. The service layer 160 may have internal elements, such as query providers 120, web services 130, and internal client services 140. In a traditional business system, the service layer coordinates requests between the client applications 170 and/or other applications 120, 130, 140. In an embodiment of the present system, a BQL engine 100 provides an interface between backend applications 150 and the various applications, including client applications 170.

When a client application 170 sends a request for data and/or services to be provided by the backend applications 150, the request may be formulated using a structured query language. The BQL engine may receive the structured request, and translate it into a native request that can be understood by the target applications and/or business objects contained in the applications. The backend applications 150 may contain typical business objects 190, with each business object having nodes 191, 195, each node storing various elements 192, 193. As described in further detail below, a structured request sent by a client application may reference a specific business object, node, and/or property within one or more of the backend applications.

The BQL engine 100 may include sub-components to realize various functions performed by the engine. For example, a parser 101 may receive, analyze, and/or decompose structured queries received from various requesters 170, 120, 130, 140. An execution decider 102 may determine appropriate business objects to receive translated queries, perform tests to determine efficient query execution strategies, and/or otherwise route translated queries to backend applications. It also may formulate an estimated execution process or time, such as when an “explain plan” request is received with the structured query, and determine whether an indexed view exists that can be used to provide results for the structured query. A native query translation engine 105 may translate the a query into a query format native to a target business object. For example, if the parser 101 decomposes a structured query, the components of the query may be passed to the native translation engine 105, which can use the components to construct a query for processing by a business object, node, or backend application. Other components may be included in or in communication with the BQL engine, such as a fast search infrastructure (FSI) 103 and/or a local client proxy (LCP) 104. The FSI 103 and LCP 104 may provide indexing and other services to enhance query execution within the business system. For example, additional service interfaces may be provided to streamline queries sent to business objects, such as where a FSI engine is used to index data or data structures within business objects. The FSI may maintain indexed views of data stored in the backend, allowing for faster access by a client. The indexed views may be particularly useful when data is requested from multiple business objects and/or nodes. The FSI may be part of the BQL engine or, as further described below, it may be resident on a separate index server.

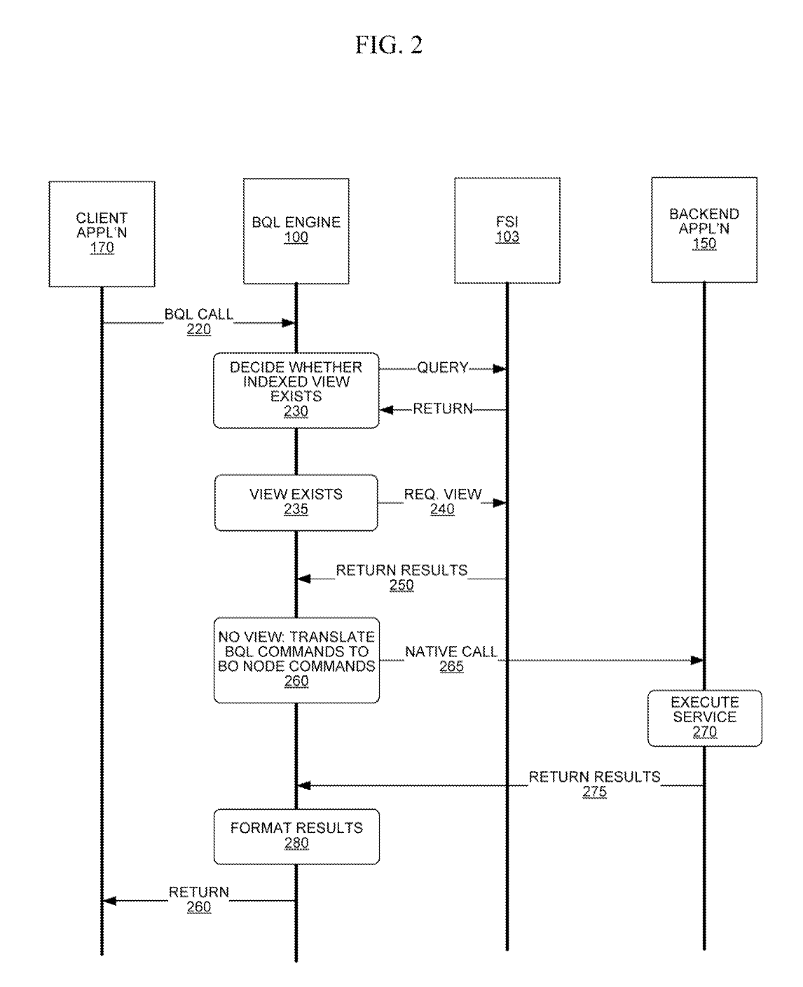

FIG. 2 shows an exemplary request and service execution in an embodiment of the present invention. A client application 170 may send a service request 220 to a BQL engine 100 in a business system. The request may be initially processed by or transmitted via a service layer (not shown). The initially-generated request may be a structured query, such as a BQL request, or it may be another type of request. For example, the service layer may present a user interface to the client application 170, with interface components that are tied to or can generate a BQL request. In such an embodiment, an operator of the client application may select an interface component, and the client application and/or the service layer may generate a structured query based on a user selection. The structured query may be defined during design or configuration of the business system and associated with a user interface element which is presented to the client application. Typically, the client application will include a BQL request defined when the interface is developed, that is associated with a user interface element. When the interface element is operated by a user, the BQL call 220 is sent to the BQL engine.

A structured query such as a BQL call 220 may then be sent to the BQL engine from the client application or the service layer. Generally, the BQL engine may receive structured queries and determine whether to utilize an indexed view or translate them into native queries appropriate for a target application, business object, and/or business object node. In the exemplary process shown in FIG. 2, the BQL engine 100 first decides whether an indexed view exists 230, such as by querying a fast search infrastructure (FSI). The BQL engine also may keep a list or description of BQL queries for which indexed views are available. If an indexed view exists 235, the BQL engine requests the view (or data made available by the view) from the FSI 240, and receives 250 indexed view results from the FSI. If no appropriate indexed view exists 260, the BQL engine translates the BQL call 220 into commands that can be processed by a node in the backend application 150, and sends the native commands 265 to the backend application. The backend application, business object, or node may receive the native commands and execute an appropriate service 270. Results generated by the execution of the service may be returned 275 to the BQL engine or another appropriate entity in the business system. In an embodiment, the BQL engine or another process in the system may format the results 280 for presentation to the user. For example, the BQL call 220 may specify that the results are to be returned in a flat result structure. The results also may be returned in a structured result, such as an XML file or other format. The BQL engine may then return the appropriately-formatted results to the client application 260. As previously described, the results 260 may first be returned to a service layer, which then communicates with the client application.

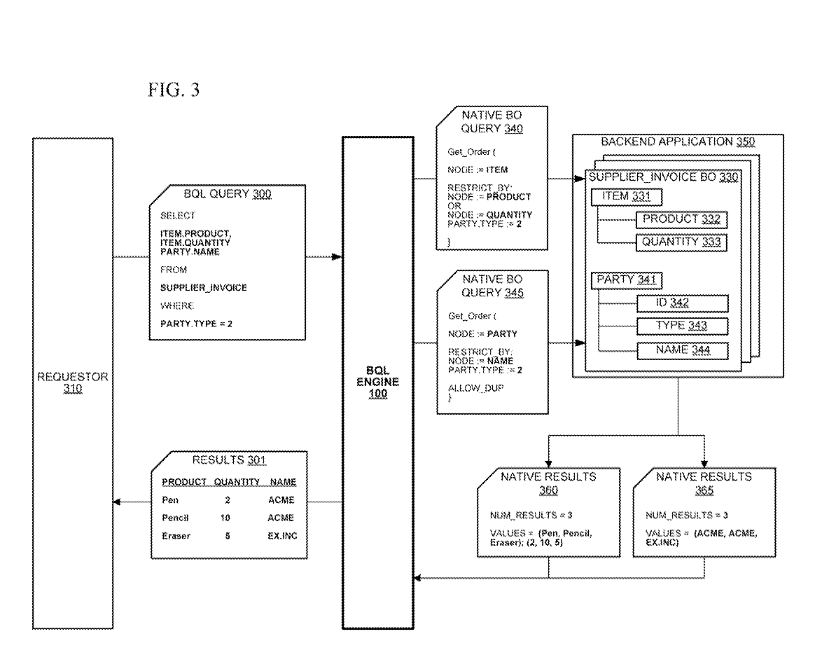

As a specific non-limiting example, FIG. 3 shows a data flow diagram including exemplary queries and results according to an embodiment of the invention. The exemplary business system includes a backend application 350 that uses a business object to hold supplier invoices, Supplier_Invoice 330. The Supplier_Invoice business object has two nodes, Item 331 and Party 341. The Item node identifies various items in the invoice, and includes the two properties Product 332 and Quantity 333, to specify a product ordered and a corresponding quantity. The Party node has three properties, ID 342, Type 343, and Name 344 to store information about the supplier associated with the invoice.

When a client application, service layer, or other requester 310 wants to extract information from a business object, it may construct a structured query. Still referring to the specific non-limiting example of FIG. 3, consider a requester that wishes to determine the quantities of products and names of suppliers delivered by a suppliers of type 2. In such a situation, the requester may construct a structured query 300. The structured query may be defined during development or configuration of the business system in which the requester is operating. For example, the structured query may be defined when the business system is configured for a particular client, and associated with a user interface that generates the desired report. The structured query uses a predefined grammar including a SELECT clause that identifies target values (i.e., nodes and/or properties), a FROM clause that identifies a target business object, and a WHERE clause that sets any desired restrictions. In the example, the values desired are the Product, Quantity and Name properties of the Item node, the business object is the Supplier-Invoice business object, and the restriction is that only those invoices associated with suppliers of type 2 should be considered. The structured query 300 may be received by a BQL engine 100, which parses the structured query. As previously described, if an indexed view appropriate for use with the structured query exists, the BQL engine will utilize the view to obtain results for the query. In the example illustrated in FIG. 3, no such indexed view exists. Therefore, the BQL engine parses the structured query into queries that can be processed by the target business object (Supplier_Invoice). For example, the BQL engine 100 may construct the native queries 340 and 345 that conform to the format and structure of queries expected by the Supplier_Invoice business object 330. It will be understood that the native queries 340 and 345 are provided as non-limiting examples, and that different applications, business objects, and/or nodes may utilize various different structures and formats for native queries.

When the native queries 340, 345 are received by the backend application 350, a service associated with the native query (such as a “Get_Order” service) may be executed for each query. In this example, the service extracts the information from the nodes and properties identified in the native queries 340, 345. The extracted information typically is returned in a format native to the service, such as the native results 360, 365. Since the backend application, business object, and related services are only aware of the native queries 340, 345 (and not the structured query 300), a separate result may be generated for each query. The native format may use a flat file, data stream, or other data transfer format with a specific structure. The native results 360, 365 may be returned to the BQL engine as the requesting entity. The native results can then be translated into structured results 301 before being sent to the client application or other requester 310. For example, the results may be placed in a table showing related values in common rows, as shown in FIG. 3. Notably, when structured queries are sent to a BQL engine, a structured query may generate multiple native queries. That is, a client application may replace multiple native queries with a single BQL query. This may be particularly useful in environments where round-trip communications are costly, such as in distributed environments with high latency. It may also reduce complexity in queries used by the client application, and improve performance by moving complex search or query structures from the client to the backend infrastructure.

It will be understood that the system and communication shown in FIG. 3 are exemplary only, and embodiments of the present invention may include additional layers, systems, and/or communication. For example, the BQL engine 100 may not interface with the backend applications directly, but instead may call an intermediate layer. Similarly, results 301 may be transmitted to a service layer before being sent to the requester 310. If an FSI is present, it may be integrated with the BQL engine or may be a separate entity.

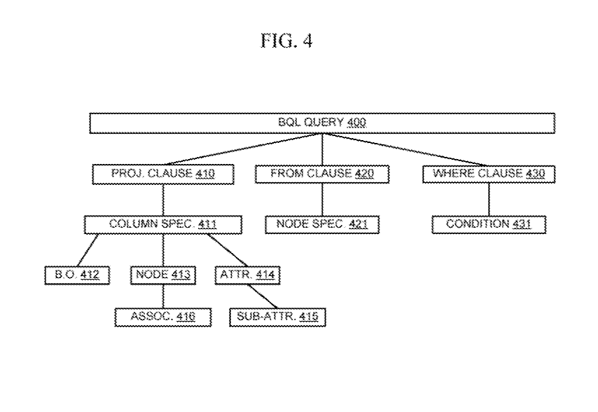

FIG. 4 shows an exemplary structure for a structured query according to the present invention. A BQL query 400 may include a projection clause 410, a from clause 420, and a where clause 430. The projection clause may specify the structure of a result set by listing elements and attributes that should be part of the result set. From the projection clause the type of the result structure can be derived, including whether the results should be presented as flat or structured results. The projection clause may define the set of columns that are visible in the result set. Wildcard operators, such as the * operator used in database SQL, may be used.

The projection clause may include a column specification 411 to identify the part of a business object that should be included in a result, including a business object node or attribute. The column specification may include an identification of the appropriate business object 413 and an identification 412 of the node or part of the business object to be included in the result. The column specification also may identify the node 413 to which the query is directed, as well as any associations 416 desired in the query. Attributes 414 and sub-attributes 415 of the column may be specified. Aliases may be specified for the headings of the result set.

The from clause 420 may specify a business object node from which data is selected by including a name or other identifier 421 of the appropriate node.

The where clause 430 may restrict tuples returned in the result set by specifying one or more conditions that must be met by result tuples. For example, boolean expressions may be included, in which case only the data sets matching the boolean expressions will be included in the result set. As a specific example, if the where clause is “WHERE ID<20,” then only data sets having an attribute ID with a value less than 20 are returned.

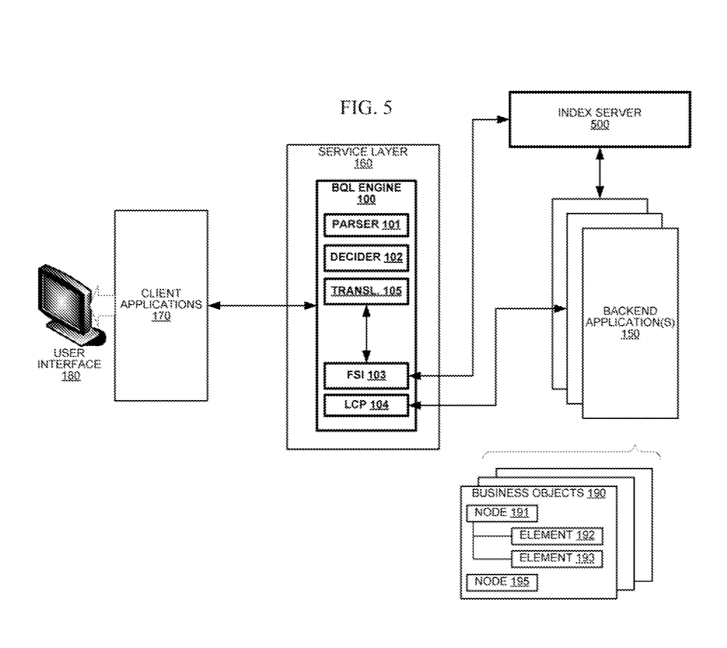

In an embodiment, the BQL engine may be configured to perform query responses using search indices and other structures. For example, FIG. 5 shows a business system in which the BQL engine 100 includes a fast search infrastructure (FSI) 103 and a local client proxy (LCP). The FSI may be used to access an index server 500 to determine if an indexed view exists for the data requested by a structured query. In an embodiment, the index server may reside on a separate physical and/or logical system from the rest of the BQL engine. As previously described, if an indexed view exists the BQL engine may use the view to provide results in response to a structured query. Since indexed views provide efficient access to data, queries that can make use of indexed views may be processed more quickly than those for which no indexed view exists. Other enhancements typically used for standard relational databases can also be used. When a BQL engine receives a structured query, it may first query the FSI engine to determine if an FSI view corresponding to the request (i.e., an indexed view of the requested data) exists. If so, the BQL engine may make a single call to the FSI engine to retrieve the desired data. For example, the structured query received by the BQL engine may be passed directly to the FSI engine. If no FSI view exists, the BQL engine may call the LCP. The LCP may translate the structured query into a native format, or it may receive the native format query from the translation engine 105. The LCP may then coordinate requests between the BQL engine, the service layer 160, and/or the various applications, business objects, and nodes referenced by the translated query.

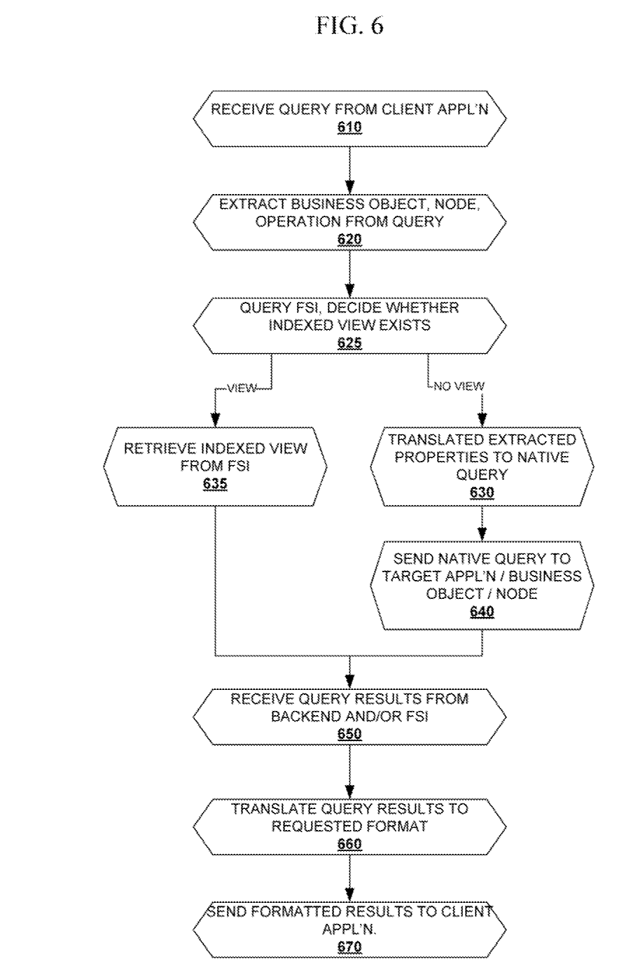

FIG. 6 shows an exemplary process used by a structured query engine. A structured query may be received 610 from a client application or other requester. The query engine may extract 620 information from the query, such as a target business object, a target node within the target business object, and an operation to be performed on the business object and/or node. Other information may be extracted, such as a restriction of which data is to be operated on, a format for query results, etc. In an embodiment, the query engine may first decide if an indexed view appropriate to the structured query exists, such as by querying a fast search infrastructure 625. If a view exists, the query engine may retrieved the indexed view and/or data stored in the view from the FSI and/or an index server as previously described. If no view exists, the query engine may translate 630 the structured query into a native query, by using the extracted information to construct a native query. Typically, the native query is constructed in the format expected by the target business object and/or node. For example, the native query may be constructed by creating a template query with the appropriate structure having empty fields, and inserting the extracted information into the empty fields. The native query may be sent 640 to the target backend application, business object, and/or node for processing. In some cases, a structured query or series of structured queries may use both an indexed view and a local client proxy to obtain results from the query or queries, such as where an indexed view exists for a portion of a complex query or for a subset of a set of received queries. Results received 650 from the backend applications and/or an indexed view can be formatted according to a format specified by the structured query 660 and returned to the client application or other requestor 670.

Additional exemplary structured queries are presented below. The examples make use of two exemplary business objects, SupplierInvoice and Product, with the structures shown below:

| Bus. Obj. Name | Node Name | Element Name |
|---|---|---|
| SupplierInvoice | Header | ID |
| | | ChangeData |
| | | Date |
| | | Amount |
| | | Currency |
| | Item | ParentID |
| | | ID |
| | | Product |
| | | Quantity |
| | Party | ParentID |
| | | ID |
| | | PartyType |
| | | Name |
| | SellerParty | |
| | BuyerParty | |
| Product | Header | ID |
| | | Description |

For demonstration purposes, the following exemplary data set will be used. Each table shows the data for one business object node:

SupplierInvoice Header
ChangeData

| ID | CreationDate | LastChangedDate | User | Date | Amount | Currency |
|---|---|---|---|---|---|---|
| 1 | 10.05.2006 | 19.11.2006 | WUGGI | 05.05.2006 | 100.00 | EUR |
| 2 | 25.06.2006 | 25.05.2006 | HUGO | 26.06.2006 | 5.99 | USD |

SupplierInvoice Item

| ParentID | ID | Product | Quantity |
|---|---|---|---|
| 1 | 1 | Ref to 2 | 2 |
| 1 | 2 | Ref to 1 | 10 |
| 2 | 3 | Ref to 3 | 1 |

SupplierInvoice Party

| ParentID | ID | PartyType | Name |
|---|---|---|---|
| 1 | 1 | 1 | EXAMPLE Inc. |
| 1 | 2 | 2 | IO Ltd. |
| 2 | 3 | 2 | ACME Crop. |
| 2 | 4 | 1 | Test AG |

Product Header

| ID | Description |
|---|---|
| 1 | Pen |
| 2 | Pencil |
| 3 | Eraser |

A structured query may be used to select all Header nodes of the Supplier Invoice business object. For example, the following query may be used:

SELECT siv˜ID AS id FROM SupplierInvoice.Header AS siv

The result set for such a query contains the IDs of all SupplierInvoice business objects. The type of the result structure may be derived from the projection part of the structured query (i.e., “siv.ID”). In this case, the result structure may contain one element with a simple type. Hence, the result can be represented as a single-column result table, specified by the alias ‘id’:

id
1
2

More complex structured queries may be used, such as queries that include an implicit join of multiple elements. For example, the query

SELECT siv.Party˜Name AS name FROM SupplierInvoice.Header AS siv

provides the Name attribute of the Party node. When the query is translated to a native query format, queries sufficient to extract the relevant data from multiple nodes may be constructed. First, instances of the Supplier Invoice Root node may be selected. For these Root node instances, all Party node instances may be retrieved. The result structure includes the Name attribute of the Party node, which has a simple data type and thus can be represented as a single-column table with one column. The alias for the selected attribute provides the column name for the result table:

name

EXAMPLE Inc.
IO Ltd.
ACME Crop.
Test AG

A similar structured query may include a further restriction in the WHERE clause:

SELECT siv.Party~Name AS name
FROM SupplierInvoice~Header AS siv
WHERE siv.Header~ID = 1

In this case, only Supplier Invoice Header nodes are selected which have the ID 1:

name

EXAMPLE Inc.
IO Ltd.

A system according to the present invention may also return query results in a structured format. Structured results may be suitable for services that allow for structured data, such as a Web Service based query service. In an embodiment, XML or a similar representation format may be used for structured results. For example, the following query may select Supplier Invoice Header nodes and the Item nodes associated with each:

SELECT siv, siv.Item TRANSPORTING (ProductID, Quantity)
FROM SupplierInvoice.Header AS siv

In this query, all attributes of the Header node may be transported. The attributes ProductID and Quantity are returned for the implicitly-joined Item nodes. In XML notation, the results of this query using the above sample data set may be returned as:

```
<BQLresultSet>
  <siv>
  <ID>1</ID>
  <ChangeData>
    <CreationDate>10.05.2006</CreationDate>
    <LastChangedDate>19.11.2006</ LastChangedDate >
    <User>WUGGI</User>
  </ChangeData>
  <Date>05.05.2006</Date>
  <Amount>100,00</Amount>
  <Currency>EUR</Currency>
  <siv.Item>
    <ProductID>2</ProductID>
    <Quantity>2</Quantity>
    <ProductID>1</ProductID>
    <Quantity>10</Quantity>
  </siv.Item>
  </siv>
  <siv>
  <ID>2</ID>
  <ChangeData>
    <CreationDate>25.06.2006</CreationDate>
    <LastChangedDate>25.05.2006</LastChangedDate>
    <User>HUGO</User>
  </ChangeData>
  <Date>26.06.2006</Date>
  <Amount>5,99</Amount>
  <Currency>USD</Currency>
  <siv.Item>
    <ProductID>3</ProductID>
    <Quantity>1</Quantity>
  </siv.Item>
  </siv>
</BQLresultSet>
```

As another example, the following query demonstrates the use of an alias in a structured result:

SELECT siv AS MySIV TRANSPORTING (ID)
FROM SupplierInvoice.Header AS siv

The alias name “MySIV” in the projection provides the name for the element in the structured result set:

```
<BQLresultSet>
  <MySIV>
  <ID>1</ID>
  </MySIV>
  <MySIV>
  <ID>2</ID>
  </MySIV>
</BQLresultSet>
```

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method for executing a query in a business system, comprising:
receiving a first query specifying a business object, a node in the business object, and an operation to be performed with the business object, the first query defined in a structured query language;
extracting identifiers corresponding to the business object, the node, and the operation from the first query;
translating the extracted information into a second query, the second query defined in a native query format of the business object;
sending the second query to a backend application storing the business object;
receiving a query result from the backend application; and
presenting the query result from the backend operation.

2. The method of claim 1, wherein the first query comprises a projection clause, a from clause, and a where clause.

3. The method of claim 2, wherein the from clause specifies a business object node.

4. The method of claim 1, wherein the query result is presented in a flat result structure.

5. The method of claim 1, wherein the query result is presented in a structured result structure.

6. The method of claim 1, wherein the backend application is accessed via a client proxy.

7. The method of claim 1, wherein the first query comprises a restrictive condition to limit the business object nodes affected by the operation.

8. A method for executing a query in a business system comprising:
receiving a first query specifying a business object, a node in the business object, and an operation to be performed with the business object, the first query defined in a structured query language;
extracting the business object, the node, and the operation from the first query;
querying a search infrastructure to determine if an indexed view of data requested by the first query exists;
if an indexed view exists:
sending the first query to the search infrastructure; and
receiving a query result from the search infrastructure;
if no indexed view exists:
translating the extracted information into a second query, the second query defined in a native query language of the business object; and
sending the second query to a backend application storing the business object;
receiving a query result from the backend application; and
presenting the query result from the backend operation.

9. The method of claim 8 wherein, if no indexed view exists, the second query is sent to the backend application using a local client proxy.

10. The method of claim 8 wherein the first query comprises a restrictive condition to limit the business object nodes affected by the operation.

11. A method of accessing data from a backend application, comprising:
constructing a structured query referencing at least one business object, each business object having a plurality of nodes, the structured query specifying a restriction on at least one of the plurality of nodes;
using a portal interface, sending the structured query to a business system having a backend application storing the referenced business object; and
receiving a query result from the business system, the query result containing data corresponding to nodes filtered by the restriction.

12. The method of claim 11, wherein the query result contains data corresponding to nodes from multiple business objects.

13. The method of claim 11, wherein the query result is a structured result set.

14. The method of claim 11, wherein the query result is a flat result set.

15. An apparatus comprising:
an input to receive a structured query;
a parsing engine to extract a business object operation referenced by the structured query;
a decider module to determine whether an indexed view of data requested by the structured query exists;
a native query engine to construct a new query in a language native to the backend application; and
an output to send the new query to the backend application.

16. The apparatus of claim 15, comprising a fast search infrastructure to index data stored in the backend application and provide indexed views of the data to at least one of the parsing engine and the decider module.

17. The apparatus of claim 16, comprising a local client proxy to execute queries referencing a business object not indexed by the search infrastructure.

18. The apparatus of claim 15, wherein the structured query comprises a projection clause, a from clause, and a where clause.

19. The apparatus of claim 15, wherein the input is in communication with a client application displayed in a portal user interface, the client application to create the structured query.
